(19) United States
(12) Patent Application Publication
(10) Pub. No.: US 2010/0096469 A1
(43) Pub. Date: Apr. 22, 2010

(54) SPREADER APPARATUS FOR VEHICLES

(75) Inventors: Andrew M. Holverson, Manchester, IA (US); Glenn L. Ungerer, Swisher, IA (US); Shannon B. Richardson, Earlville, IA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Henderson Enterprises, Inc., Manchester, IA (US)

(21) Appl. No.: 12/488,284

(22) Filed: Jun. 19, 2009

Related U.S. Application Data
(62) Division of application No. 11/221,963, filed on Sep. 8, 2005, now abandoned.
(60) Provisional application No. 60/608,044, filed on Sep. 8, 2004.

(51) Int. Cl. B05D 1/40

(52) U.S. Cl. 239/11

(57) ABSTRACT

A vehicle including a dump body and spreader for selectively dumping and spreading materials. The vehicle includes, at least, a chassis, a body, and a spreader apparatus with a belt mechanism. A hoist is provided which extends between the body and the chassis for pivoting the body about a hinge. A tailgate is located at the rear of the body wherein the tailgate is pivotably mounted to the body. The tailgate has an opening therein to permit material to flow therethrough from the dump body to an auger assembly. The auger assembly includes an auger, which directs material to an opening through which the material will fall into the spreader apparatus. The spreader apparatus includes a body with an inlet and outlet, a belt mechanism driven by a motor, a mounting mechanism to attach it to the vehicle. The belt is driven by a motor that is controlled by a control system located in the vehicle. The control system monitors vehicle speed and then runs the belt at a speed such that all materials dispensed from the spreader outlet will have a velocity equal an opposite to that of the vehicle, or zero speed relative to the ground.

### CROSS-REFERENCE TO RELATED PATENT APPLICATION

This patent application is a division of co-pending U.S. patent application Ser. No. 11/221,963, filed Sep. 8, 2005, and entitled “Spreader Apparatus,” which claims the benefit of priority to U.S. Provisional Application No. 60/608,044, filed Sep. 8, 2004, and entitled “Spreader Apparatus,” the foregoing applications being incorporated in their entireties herein by this reference.

### FIELD OF THE INVENTION

The present invention relates generally to a spreader apparatus which, when mounted onto a vehicle, provides for selective spreading of material from the apparatus, advantageously granular material such as sand, salt and the like, onto surfaces such as roadways.

### BACKGROUND OF THE INVENTION

Many types of vehicles are available with an apparatus mounted thereto which provide for the spreading of material, such as sand, salt, gravel, asphalt and the like, onto a surface. Conventional spreaders have been commercially available from, for example, Henderson Manufacturing Company, Monroe Truck Equipment, Swenson Spreader, and Tyler. A conventional vehicle can optionally include a conveyor system that transports material residing within a body of the vehicle out of the body and into one or more spreaders mounted to the exterior of the vehicle. Such conveyor systems typically includes a longitudinal endless conveyor located within the body that transports the material from the front to the rear of the body or, alternatively, from the rear to the front of the body. The former situation typically results in a deposit of the material into a conventional spreader mounted on the rear of the vehicle. In the latter situation, however, the material is transported out of the front of the body, through a gate, and onto another part of the conveyor system—a cross conveyor—mounted on the chassis, and located adjacent the front of the body. The cross conveyor in turn transports the material laterally to the sides of the vehicle, and deposits the material into conventional side-mounted spreaders.

Today, municipalities often dispense granular materials on roadways during slick winter conditions to improve traction for vehicles driving in those conditions. Salt is sometimes used to melt snow and ice, while other materials, sand, for example, can be used to improve traction. Significant direct costs are incurred in this process, including the materials themselves—salt being especially expensive—as well as equipment and labor costs involved in the application of the materials. Time is also spent traveling to and from the stockpiles of material and back to the various routes throughout the region, which can lead to delay in applying such materials to the roadways.

In the past, the placement process of such material on roadways has commonly involved two methods. The first method utilizes a rotating “spinner disc.” Metered amounts of granular material are dropped onto the spinning disc, which spins about a vertical axis. This disc includes a series of ridges or vanes oriented in a wagon-wheel arrangement. The disc throws the material in a pattern on the roadway. A slow turning disc will distribute the material in a relatively narrow pattern (approximately a few feet in width), whereas higher revolutions can create spread width patterns of forty feet or more.

The second common method for spreading materials on roadways is to drop the material directly onto the road surface in either a narrow strip or sometimes metered across a much wider path, approximately six to seven feet. The narrow strip is accomplished by discharging the material through a single opening. A wider path can be created using a “roll type” spreader. However, both of these methods involve dropping material straight down onto the roadway.

The material is typically dispensed from a truck or other vehicle moving anywhere from about 5 mph to approximately 50 mph, and thus is traveling at the vehicle speed relative to the ground. In other instances, the material can be moving at a constant velocity relative to the ground that is different than the vehicle speed. In the case, for example, where the granular material is traveling at the speed of the vehicle relative to the ground, the material tends to bounce along the ground for some distance until it finally comes to rest. This bouncing action can result in about half, or sometimes more, of the granular material leaving the roadway. The problems with this result are many.

First, to ensure adequate road surface coverage, application rates are usually increased to compensate for losing the material to non-roadway surfaces. Having to spread more material than otherwise would be needed increases material costs. Further, the truck's finite material storage capacity is exhausted sooner than if the vehicle were dispensing less material. Fuel costs increase as many more trips are made to and from the material stockpiles. More equipment and operators are needed to cover the roads within the same time period because of this increase in lost time traveling to stockpiles. Tens of thousands of dollars are wasted by counties and cities throughout the Snow Belt from the inability to reliably and accurately place materials on the road surface.

There are other spreader designs available that have attempted to increase material retention on the road surface by minimizing the differential speed of the particle and the road. Material spreaders of this type have involved several designs. All designs thus far have had many drawbacks associated with them. Some designs are very complex and costly. Also, reliability is a problem as this equipment operates in a tough environment, including freezing temperatures, corrosive materials, wet conditions causing materials to stick and plug the spreaders, heavy parts, etc.

In view of the foregoing, there exist various needs in the art. One such need is for a spreader that can dispense material onto a road surface with improved retention thereon. Another need is for such a spreader that is robust and economical.

### SUMMARY OF THE INVENTION

The present invention addresses the foregoing and other needs by providing a spreader apparatus that utilizes a belt drive to impart a velocity onto the material being dispensed relative to the ground that is substantially close to zero. This technology allows for greater speeds and yet reliable service. The design accelerates the particles in a single linear direction while many other designs continue to use the rotating disc concept. The spreader apparatus of the present invention is simple in design, light weight and designed to minimize problems with the plugging of wet material.

The spreader apparatus can use hydraulic power to drive the belt as well as to direct the discharge and to lift the assembly to a transport (out-of-service) position. In some embodiments, the belt has interior drive cogs which positively engage the drive pulley. Since the material falls on the belt and is discharged out the rear, energy losses due to high friction (as seen on rotating disc designs) and inefficiencies (on air blower designs) are eliminated. No other spreaders are known of that utilize a belt-type mechanism as included herewith.

The inventive spreader is light and compact which helps reduce costs. Also, the inventive spreader is readily mounted to a vehicle and controlled on the back of a snow truck. A much larger material entrance opening is possible with the new design which dramatically reduces problems associated with plugging of wet materials.

This design also allows for spreading material at even higher road speeds than allowed by other designs. This is an important safety consideration as snow trucks are often out preparing road surfaces prior to storms. The closer the speed of the material-dispersing vehicle is relative to the speed of other vehicles on the road, the less the chance there is of other vehicles colliding with the snow truck. Additionally, truck routes can be covered in less time.

These and other features of the present invention will become apparent to one of ordinary skill in the art upon reading the detailed description, in conjunction with the accompanying drawings, provided herein.

### BRIEF DESCRIPTION OF THE DRAWINGS

FIG. 1 is a side elevational view of an embodiment of the present invention showing a vehicle including a dump body with an undertailgate conveyor and an embodiment of a spreader apparatus in accordance with the present invention, wherein the dump body is in a raised, dumping position.

FIG. 2 is a side elevational view of the vehicle of FIG. 1 wherein the dump body is in a lowered, normal position.

FIG. 3 is an enlarged detail view taken from FIG. 2 of the spreader apparatus and tailgate of the vehicle.

FIG. 4 is an enlarged detail view taken from FIG. 1 of the spreader apparatus and tailgate of the vehicle.

FIG. 5 is a rear end elevational view of the vehicle of FIG. 1.

FIG. 6 is a perspective view of a spreader apparatus according to the present invention from a first side thereof.

FIG. 7 is a view similar to FIG. 6, but with the spreader apparatus in an operating position and a full street-side rotation position.

FIG. 8 is a view similar to FIG. 7, but with the spreader apparatus in an operating position with a full curb-side rotation position.

FIG. 9 is a bottom perspective view of the spreader apparatus of FIG. 6.

FIG. 10 is a view similar to FIG. 6, but with the spreader apparatus in a transport position.

FIG. 11 is a top perspective view of a belt housing of the spreader apparatus of FIG. 6.

FIG. 12 is a top perspective view of a belt housing of FIG. 11 with a pre-wet applicator removed for illustrative purposes.

FIG. 13 is a bottom perspective view of the belt housing of FIG. 11.

FIG. 14 is a top plan view of the belt housing of FIG. 11, illustrating a discharge pattern.

FIG. 15 is a side elevational view of the belt housing of FIG. 11.

FIG. 16 is an exploded view of a belt drive mechanism of the spreader apparatus of FIG. 6 with the housing removed.

FIG. 17 is a perspective view from a first side of another embodiment of a spreader apparatus according to the present invention for use with any suitable vehicle.

FIG. 18 is a perspective view from a first side of yet another embodiment of a spreader apparatus according to the present invention for use with any suitable vehicle.

FIG. 19 is a view similar to FIG. 18, but with the spreader apparatus in a transport position.

FIG. 20 is a perspective view of the spreader apparatus of FIG. 18 from a second side thereof, showing the spreader apparatus in an operating position with a full street-side rotation position.

FIG. 21 is a view similar to FIG. 20, but with the spreader apparatus in an operating position with a full curb-side rotation position.

FIG. 22 is a perspective view of still another embodiment of a spreader apparatus according to the present invention for use with any suitable vehicle.

FIG. 23 is an exploded view of another embodiment of a belt mechanism suitable for use in the spreader apparatus of the present invention.

FIG. 24 is an exploded view of yet another embodiment of a belt mechanism suitable for use in the spreader apparatus of the present invention.

### DETAILED DESCRIPTION OF EMBODIMENTS OF THE INVENTION

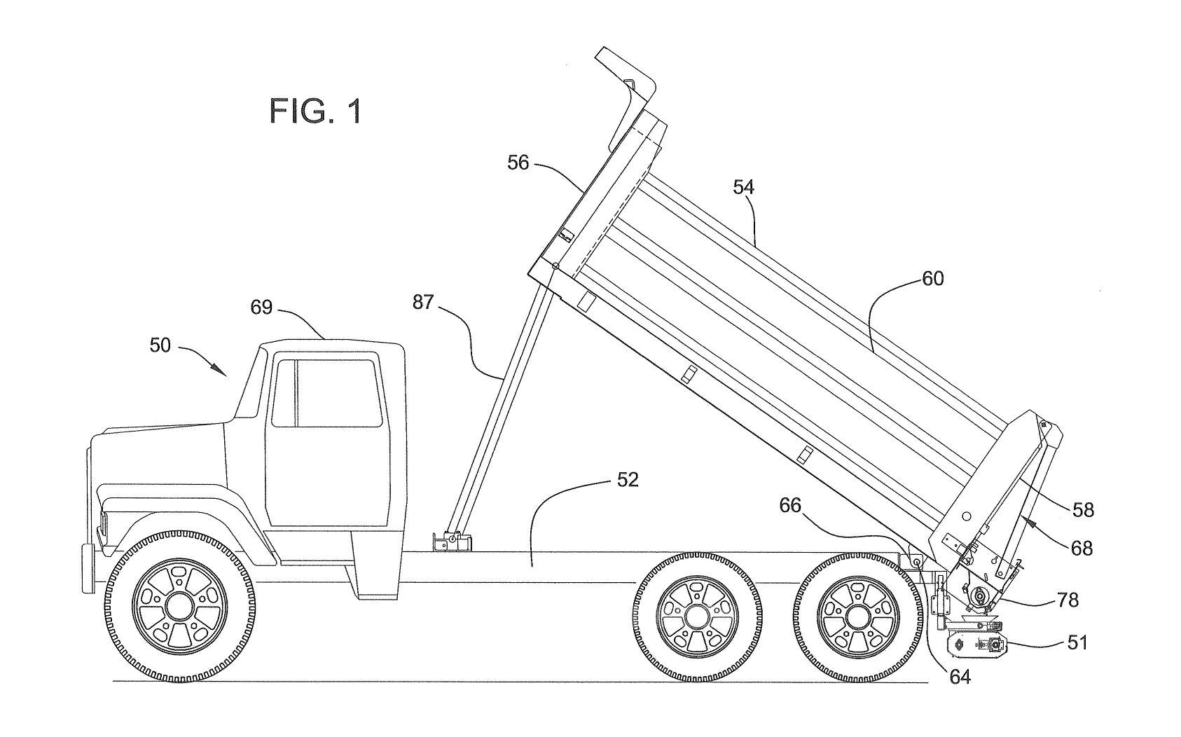

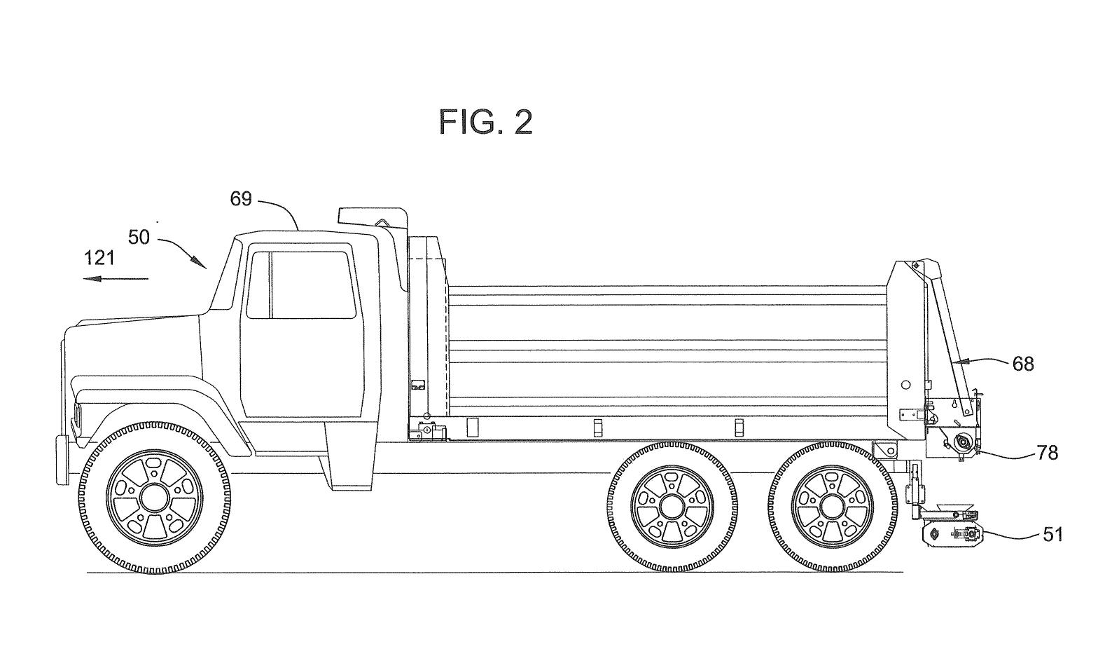

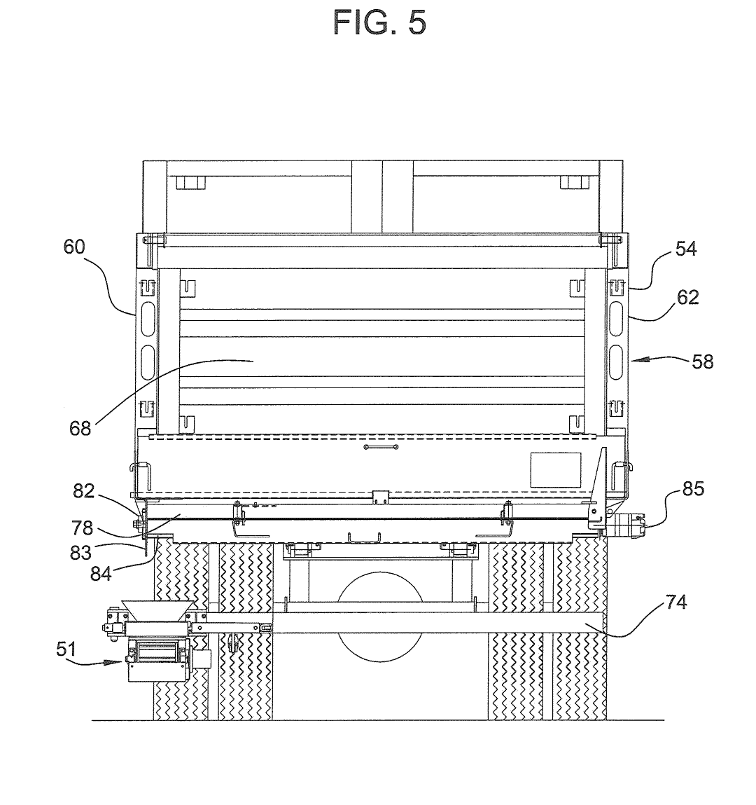

Turning now to the Figures, there is shown in FIG. 1 a vehicle 50 having a spreader apparatus 51 in accordance with the teachings of the present invention. The vehicle 50 includes a chassis 52 and a dump body 54 with an undertailgate conveyor, i.e. auger assembly 78, for selectively dumping or spreading materials stored therein pivotally mounted to the chassis 52 such that it can rotate between a raised position (FIG. 1) for dumping and/or spreading, for example, and a normal, lowered position (FIG. 2) for transport, for example. The body 54 has a front end 56, a rear end 58, and a pair of side walls 60, 62 (FIG. 5) extending longitudinally therebetween. The body 54 is secured to the chassis 52 about a pivot axis 64 that extends perpendicularly to the length of the body 54. More specifically, the body 54 is connected to the chassis 52 by a hinge 66 that allows for pivoting movement about the pivot access 64. The body 54 can have a tailgate 68 pivotally mounted to the rear end 58 of the body 54 such that the tailgate 68 can pivot about a top edge thereof. The tailgate can optionally be equipped with an opening therein that is selectively covered by a movable gate. Examples of other vehicles suitable for use in the present invention include those having standard V-box bodies, others with combination bodies, undertailgate conveyors, replacement tailgate spreaders/conveyors, and roll spreaders, and those shown and described in U.S. Pat. Nos. 6,761,525; 6,585,472; and 6,394,735, for example.

The spreader apparatus 51 can be mounted to the chassis 52 and is provided for spreading materials dispensed from the body 54 via any suitable conveyor assembly, for example. The spreader apparatus 51 according to the present invention can dispense material therefrom at a velocity that is substantially zero relative to the ground. A control system mounted in a cab 69 of the vehicle 50, for example, can be used to monitor the velocity of the vehicle relative to the ground and to drive the spreader apparatus accordingly such that it imparts a substantially similar velocity to the material being dispensed therefrom in the opposite direction of the movement of the vehicle. Examples of suitable control systems include those commercially available from Force America, such as Force America's 5100, for example, or those produced by Certified Power.

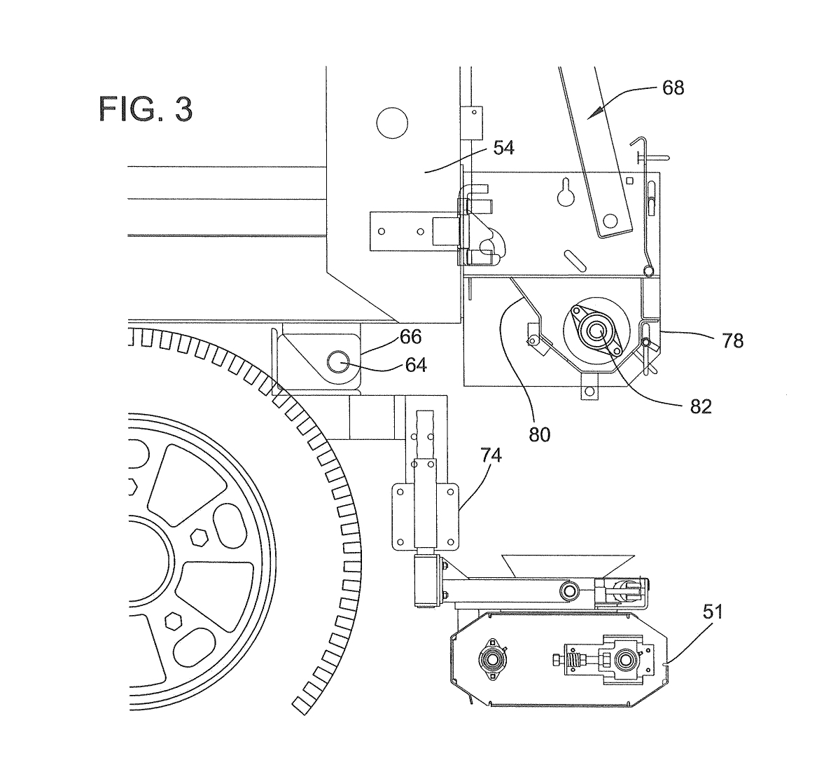

Referring to FIGS. 3-5, the vehicle can include an auger assembly 78 for delivering material from the body to the spreader apparatus 51. The auger assembly 78 is disposed below the tailgate 68 and runs the entire length of the tailgate 68 so that all material leaving the body 54 via the tailgate 68 will enter the top of the auger assembly 78. The auger assembly 78 includes an auger frame 80 that is configured such that the material leaving the tailgate 68 and entering the auger assembly 78 is channeled to the bottom of the auger assembly 78 where an auger 82 is located.

Referring to FIG. 5, the material stored by the dump body 54 can be delivered to the auger assembly 78 through the tailgate 68. The tailgate 68 is attached at the rear end 58 of the body 54 and extends transversely between the side walls 60, 62. The tailgate 68 may be in an open position, wherein material is permitted to pass from the body 54 to the spreader apparatus 51, or a closed position, wherein the tailgate will prohibit material from leaving the body 54. In operation, the auger 82 will transport material in the auger assembly 78 towards the left end or street end 83 of the auger assembly 78. At the left end of the auger assembly 78, an opening 84 is provided that permits material to exit the through the bottom of the auger assembly 78, and fall into the spreader apparatus 51.

A conveyer assembly can be disposed within the body (so-called combination body) to facilitate the transport of material out of the body 54. The conveyer assembly is located near the bottom of the body 54 and extends longitudinally between the front end 56 and the rear end 58 of the body 54. Alternatively, the conveyor assembly can extend longitudinally between side walls 60 and 62. In some embodiments, the conveyor assembly can extend predetermined distance beyond the rear end of the body or side walls of the body. The conveyor can be in the form of an endless belt, an auger, or a “chain” conveyor. The conveyer can be used to transport material from inside the body 54 out the rear end 58 of the body 54 and into the auger assembly 78. The auger 82 can be driven by a motor 85, such as a hydraulic motor. The auger assembly 78 can thus be operated using a hydraulic supply used for other components of the vehicle.

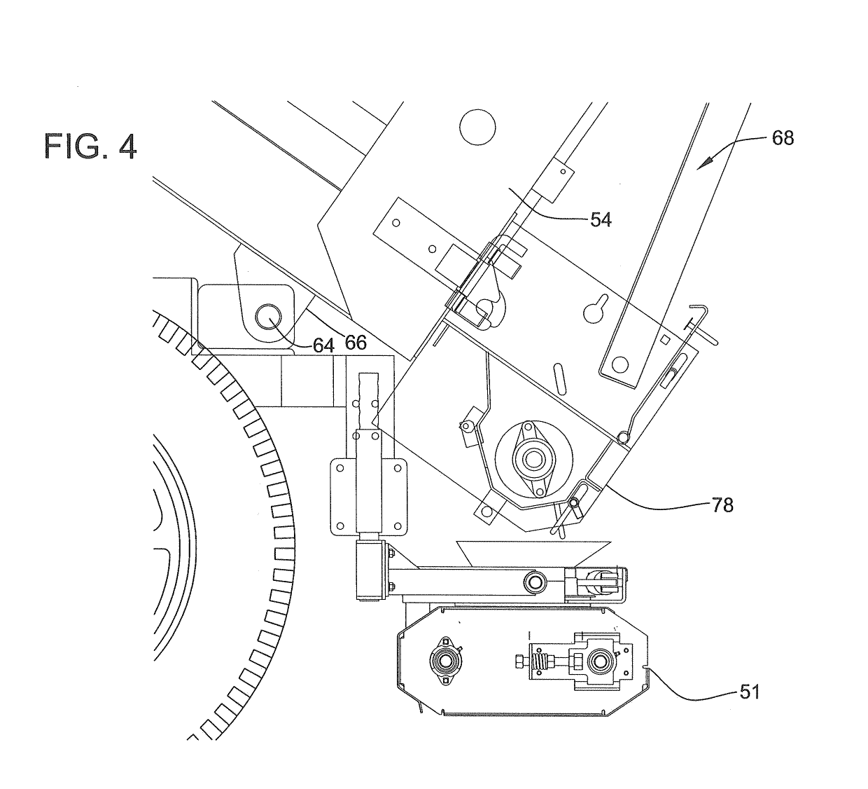

Referring to FIGS. 1 and 2, in the illustrative embodiment, the body can be moved to the raised position to provide a dumping function. A hoist 87 can be provided to move the body 54 pivotally about the pivot axis 64. In the embodiment shown, the hoist 87 is a front mounted telescopic hoist. Other types of hoists that can be provided are an underbody hoist, dual telescopic hoists, scissors hoist and the like. The hoist 87 can be connected between the body 54 and chassis 52 at a predetermined point forward of the pivot axis 64. The hoist 85, which can include a hydraulic cylinder, is operable to pivot the front end 56 of the body 54 about the pivot axis 64 from a lowered position, as seen in FIG. 2, to a raised position, as seen in FIG. 1. With the body 54 disposed in a raised position, material can rapidly flow from the body 54 out the tailgate 68. In some embodiments, the tailgate can be allowed to pivot about its upper end such that the entire tailgate swings open to allow material to flow out of the body through the opening between the body and the bottom of the tailgate. As shown in FIGS. 1 and 4, the spreader apparatus 51 is mounted to the vehicle such that the body 54 can be moved to the raised position without the spreader apparatus 51 interfering therewith.

Referring to FIG. 5, the control system can be configured to control the amount of material dispensed from the body 54 based on the speed of the vehicle, for example. The control system can use any conventional means to detect the speed of the vehicle. The control system can vary the speed of one or more of the conveyor assembly and the auger assembly 78 to vary the amount of material dispensed from the body 54. The amount of material being dispensed from the auger assembly 78 can be controlled by changing speed of the auger 82 and/or the conveyor assembly. For example, it may be desirable for the amount of material dispensed from the body to increase as the vehicle speed increases so that the surface being treated with materials is adequately covered. The control system can match a detected speed with a predetermined material dispensing rate so that the road surface is covered with a desired amount of material.

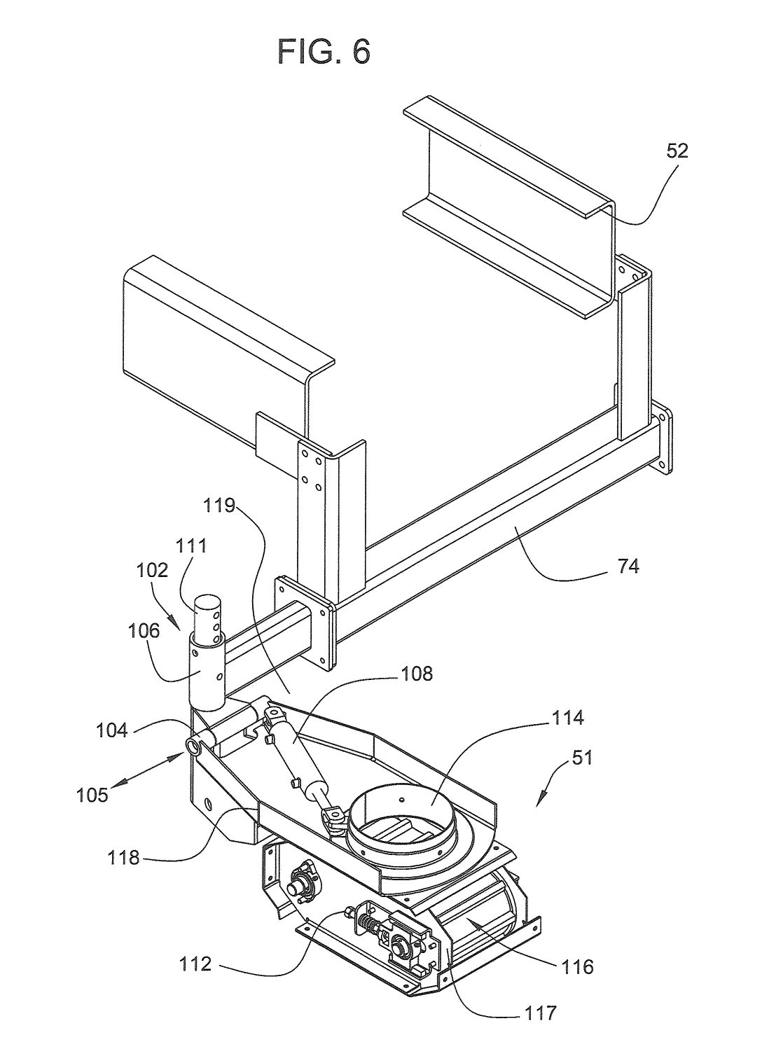

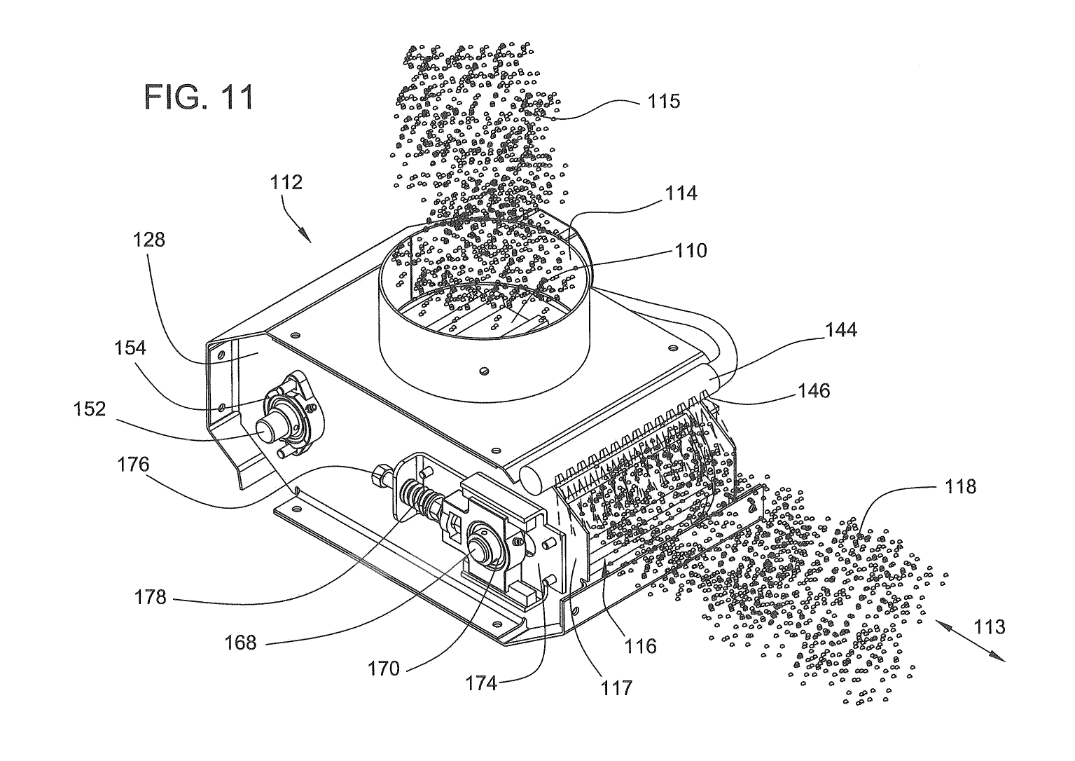

Turning now to FIGS. 6 and 11, the spreader apparatus 51 includes a mounting mechanism 102 for attaching the spreader to the chassis 52 via a mount frame 74, a belt mechanism 110 located inside a belt housing unit 112 for driving the material from the spreader in a generally linear dispensing direction 113 (FIG. 11) and for imparting a velocity to the material that can be based on the vehicle speed, a material inlet 114 disposed on top of the spreader apparatus 51 and positionable below the opening of the auger assembly for allowing material 115 to enter the belt housing unit 112, a material outlet 116 located at the distal end 117 of the belt housing unit 112 for allowing material 118 to exit the belt housing unit 112, and an adjustment mechanism 119 for selectively adjusting the position of the belt mechanism 110 relative to the ground and to the vehicle chassis.

Referring to FIG. 6, the mounting mechanism 102 can include a height adjustment mechanism 106 which can adjust the vertical position of the spreader apparatus 51 relative to the truck mount frame 74, thereby controlling the distance between the spreader apparatus 51 and the surface over which the vehicle is traveling. The height adjustment mechanism can include a collar and a post 111 including a series of mounting holes therethrough to allow for various mounting positions that can incrementally change the height of the spreader apparatus.

The adjustment mechanism 119 can include a pivot 104 that permits the spreader apparatus 51 to rotate about a pivot axis 105 between a transport position and an operating position, a pivot pan 118 extending between the pivot axis 105 and the belt housing 112, and a directional control cylinder 108 operably arranged with the belt housing 112 to rotate the belt housing relative to the pivot pan 118 about an axis 107 substantially perpendicular to the pivot axis 104.

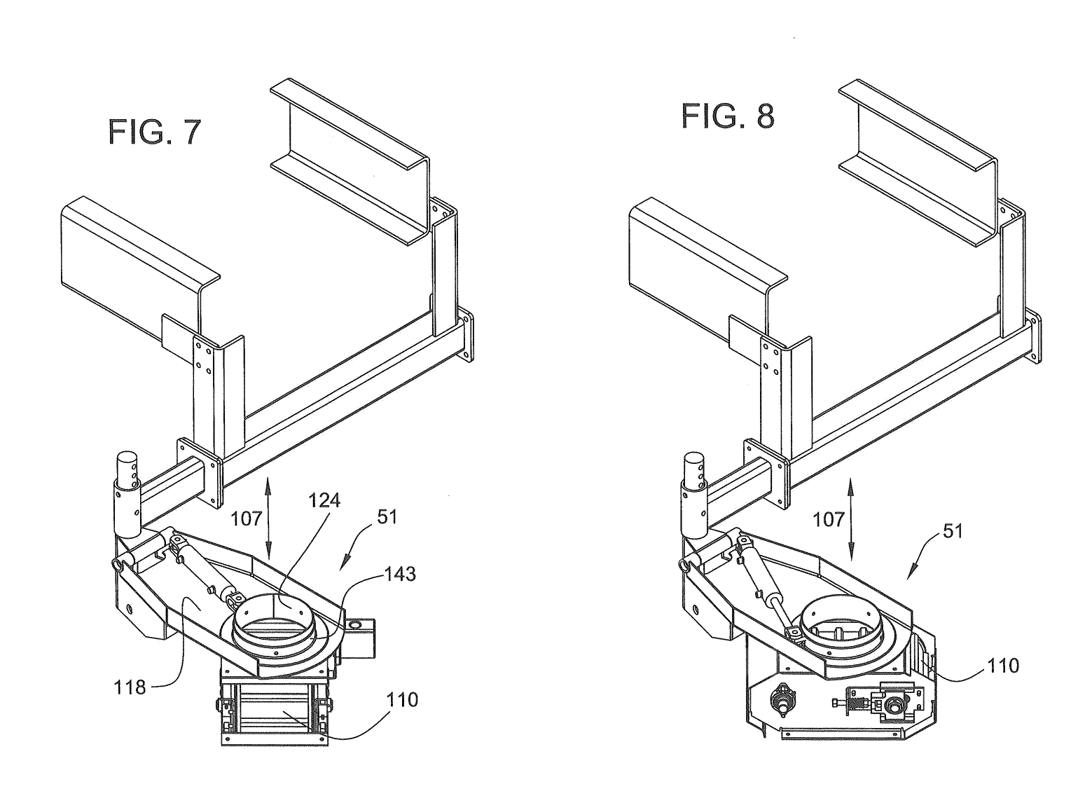

Referring to FIGS. 7 and 8, the directional control actuator 108 can be used to pivot the belt mechanism 110 about the axis 107 to control the orientation of the material discharge path between a full street side rotation, as shown in FIG. 7, and a full curb side rotation, as shown in FIG. 8. The rotational position can be adjusted, for example, for directing the material slightly across a roadway to allow for “broadcasting” of the material across the entire lane of traffic. When the spreader apparatus 51 is in the full street side rotational position, material can be dispensed toward the transverse center of a roadway, which is typically crowned. At other times, it is desirable to direct the material toward the outer edge of an exit ramp, for example, so that the material will be placed on the higher edge of the road such that the material tends to wash naturally across the roadway.

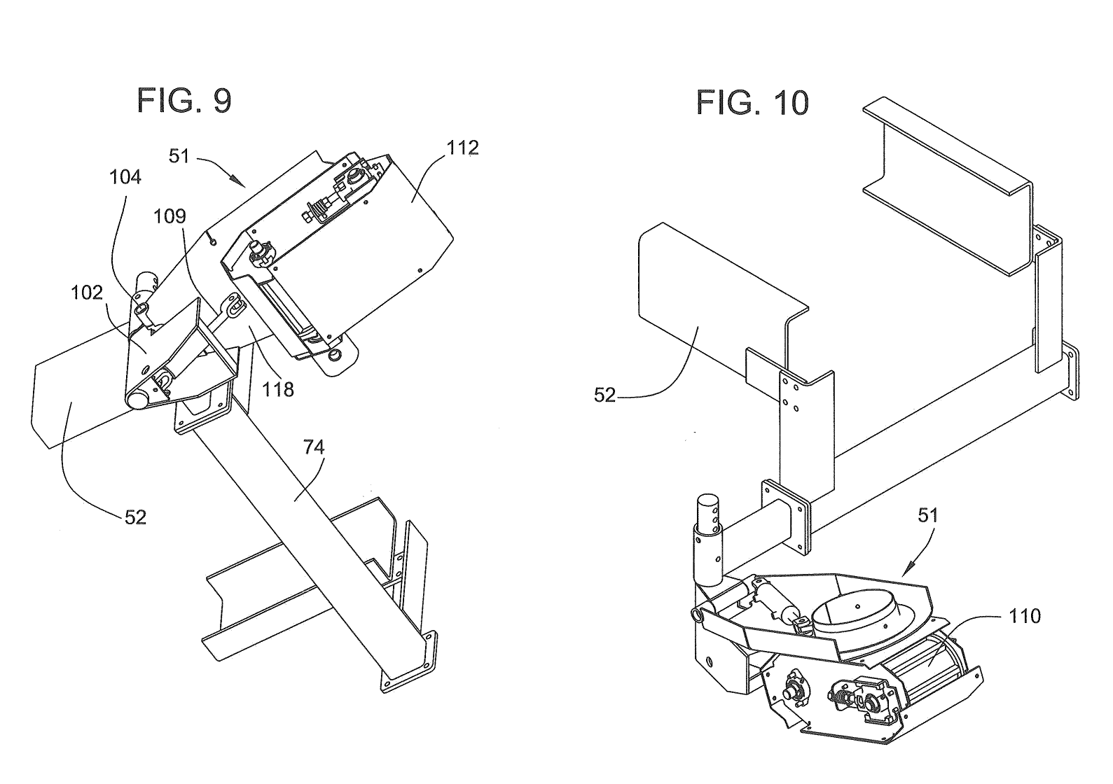

Referring to FIG. 9, the spreader apparatus 51 includes a second control actuator 109 for controlling the pitch of the belt mechanism 110. The second control actuator 109 is disposed underneath the spreader 51 and is connected between the mounting mechanism 102 and the pivot pan 118. The pitch actuator 109 is operable to pivot the pivot pan 118 and the belt housing 112 about the pivot 104. In FIGS. 9 and 10, the pitch control actuator 109 is in an actuated state so that the spreader 51 is in a transport position, the spreader 51 being pitched up from the road at an angle with respect to a horizontal plane defined be the chassis 52. When the pitch control actuator 109 is in a retracted state, the spreader 51 is disposed in an operating position wherein the belt mechanism 110 is substantially parallel to the chassis, and thus the surface upon which the vehicle stands. The spreader 51 is shown in the operating position in FIGS. 1 and 2. The pitch control actuator can be operated to maintain the belt mechanism in a substantially parallel relationship to the road surface.

Referring to FIG. 11, material can flow through the spreader apparatus 51 by being delivered thereto from the auger assembly. The material 115 exiting the auger assembly falls through the material inlet 114 into the belt housing unit 112. Once inside the belt housing unit 112, the material will land on the belt mechanism 110, which, in turn, propels the material toward the distal end 117 of the belt housing unit 112 and out of the material outlet 116. The material 118 discharged from the outlet 116 moves along the dispensing direction 113, which opposes a heading direction 121 of the forward movement of the vehicle 50 (FIGS. 2 and 15).

Referring to FIG. 11, the spreader apparatus 51 also includes a pre-wet application hose 144, which is attached to the outside of the belt housing unit 112. The purpose of the pre-wet application house 144 is to spray a liquid such as water on the material leaving the material outlet 116. The outlet 146 of the pre-wet application hose 144 is located at the discharge end of the belt housing unit 112 and situated above the material outlet 116 such that fluid leaving the hose outlet 146 is sprayed over material leaving the outlet 116. Exposing salt leaving the spreader apparatus 51 to water sprayed from the pre-wet application house 144 is advantageous because the chemical reaction required to melt ice begins when the discharged salt encounters water sprayed from the pre-wet application hose 144; thereby assisting the salt in beginning to melt ice on the road more quickly.

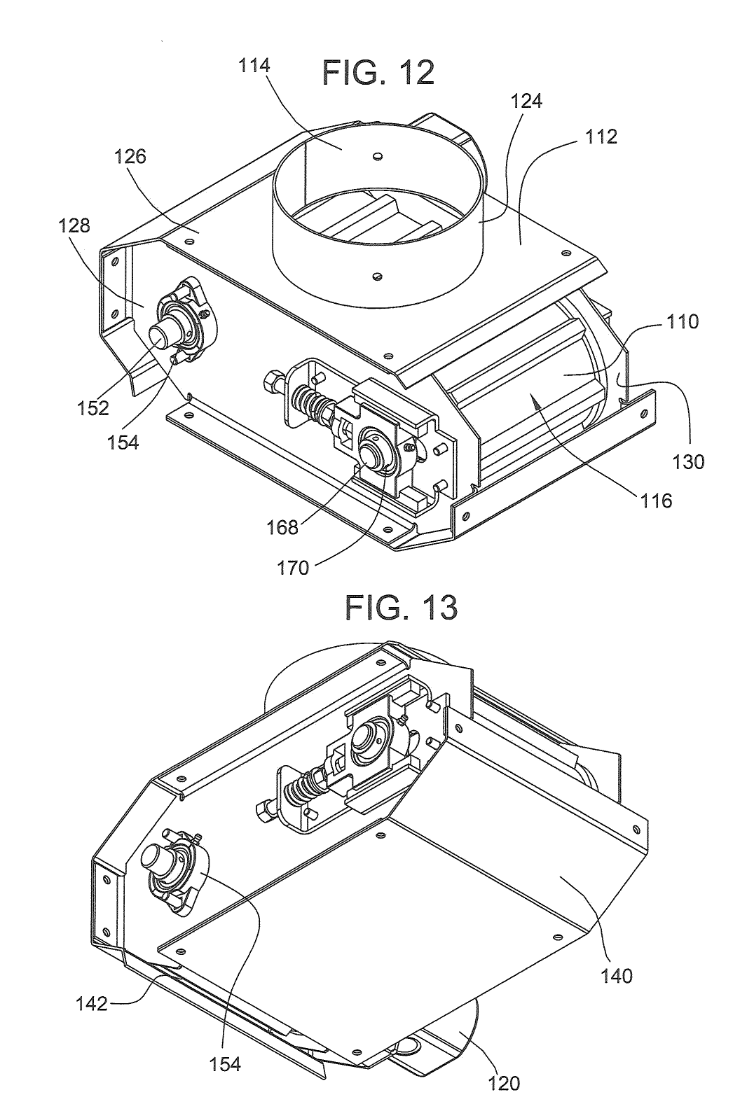

Referring to FIGS. 12 and 13, the belt housing unit 112 can include a circular inlet chute 124, which defines the material inlet 114, a top cover 126, a left side cover 128, a right side cover 130, and a bottom cover 140. The covers 126, 128, 130, 140 define the outlet 116. The belt housing unit 112 is provided with a third opening 142 to act as a clean out slot 142, defined between the top cover 126 and the bottom cover 140 and located on the underside of the belt housing unit 112 to facilitate the cleaning thereof. Referring to FIG. 7, an annular ring 143 is secured to the inlet chute 124 such that the belt housing unit 112 is pivotally mounted to the pivot pan 118 to allow the belt mechanism 110 to rotate about the axis 107.

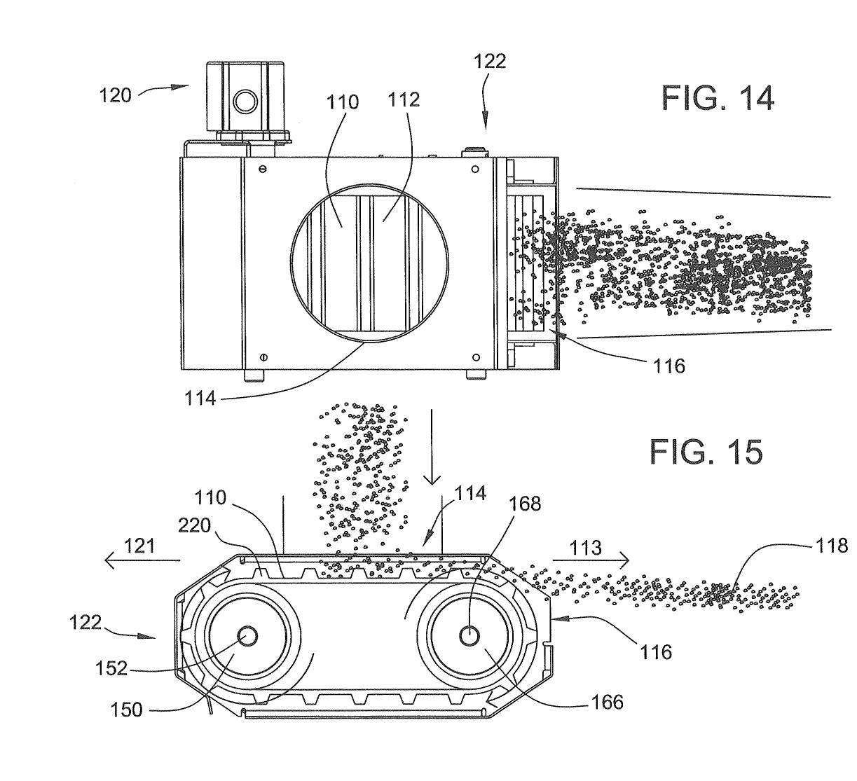

Referring to FIG. 14, the spreader apparatus 51 includes a drive motor 120 to drive the belt mechanism 110. In one embodiment, the drive motor 120 is a hydraulic motor. In other embodiments, other motors, such as an electric motor, can be used.

Referring to FIG. 15, the control system can regulate the speed of the belt mechanism 110 such that the material 118 travels in the dispensing direction 113 at a velocity that is substantially equal to the velocity at which the vehicle 50 is traveling in the heading direction 121 (FIG. 2 also), thereby reducing the velocity of the material 118 relative to the surface over which the vehicle 50 is traveling. The control system can be configured such that the belt mechanism 110 propels the material 118 from the outlet 116 with a horizontal velocity component that is equal and opposite to the forward horizontal velocity of the vehicle 50 in the heading direction, thereby discharging the material 118 from the spreader apparatus 51 substantially at zero horizontal velocity relative to the road. The result is that the material 118 will impact the road as if it was dropped from a static position from a height equal to the distance between the outlet 116 and the road surface. Consequently, the bounce and movement of the material 118 after impact with the road will be greatly reduced; thereby ensuring more material will remain on the road and within its intended location of deposit on the road.

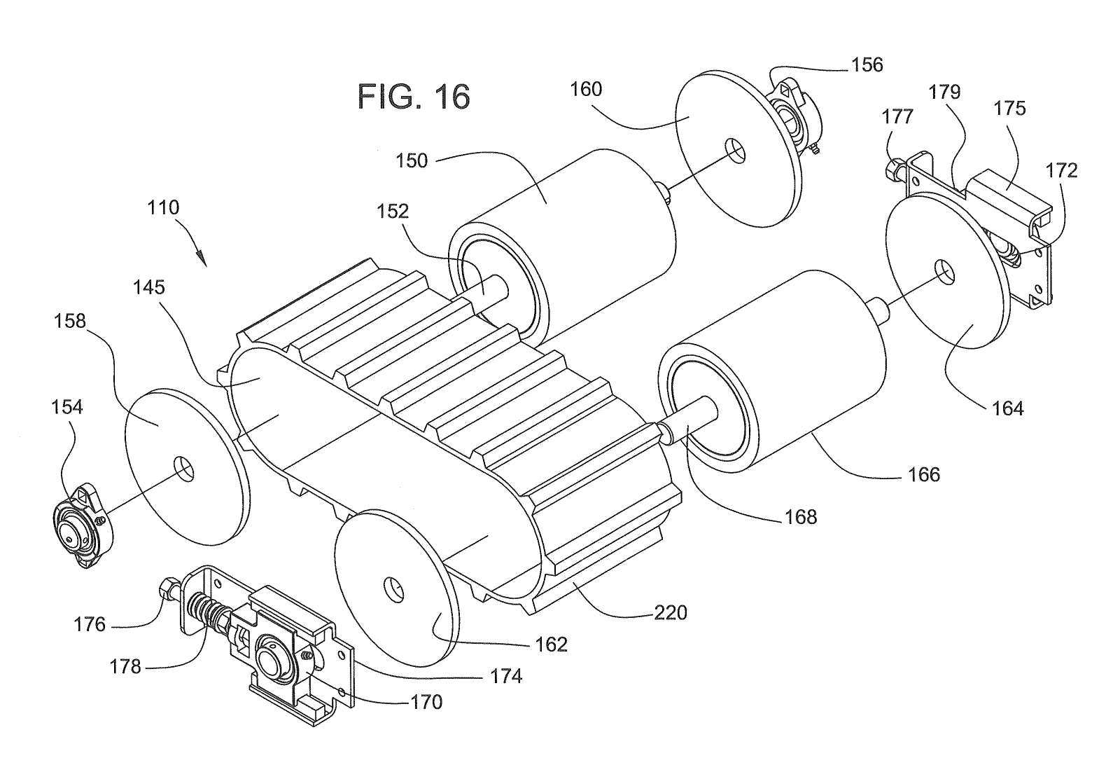

Referring to FIG. 16, the belt mechanism 110 is shown in an exploded view. The belt mechanism 110 includes a belt 145 that has a smooth inside surface. A plurality of ribs 220 are disposed in spaced relationship to each other on the outside surface of the belt 145, and are configured to engage material deposited on the belt and urge it in the direction the belt 112 is traveling, i.e., along the dispensing direction 113. The belt 145 is arranged in an endless loop disposed around a drive pulley 150 and an idler pulley 166. The belt 145 is driven by the drive pulley 150, which is driven by the drive shaft 152. The hydraulic motor 120 drives the drive shaft 152. The drive shaft 152 is secured on the left side and right side by a left roller bearing 154 and a right roller bearing 156, respectively. The left roller bearing 154 and the right roller bearing 156 are secured to the outside of left side cover 128 and the outside right side cover 130, respectively, of the belt housing unit 112, as shown in FIGS. 12 and 13. Referring to FIG. 16, also provided on the drive shaft 152 are two wear guides 158, 160, which are located on either side of the drive pulley 132.

Referring FIG. 16, the idler pulley 166 is free to rotate and rotates in response to the movement of the belt via rotation of the drive pulley 150. The idler pulley 166 is rotatably supported by an idler shaft 168 which is secured on the left side and right side by a left take-up bearing 170 and a right take-up bearing 172, respectively. Referring to FIGS. 12 and 13, the left take up bearing 170 and the right take up bearing 172 are secured to the outside of the left side cover 128 and the outside of the right side cover 130, respectively, of the belt housing unit 112. Referring to FIG. 16, two wear guides 162, 164 are also located on either side of the idler pulley 134 on the idler shaft 168.

The take-up bearings 170, 172 are adjustable to mitigate slack in the belt mechanism 110. The take up bearings 170, 172 are slidably mounted inside respective slide brackets 174, 175. The slide brackets 174, 175 are mounted to the outside of the left side cover 128 and the outside of the right side cover 130, respectively, of the belt housing unit 112, as shown in FIGS. 8 and 9. Referring to FIG. 16, threaded push arms 176, 177 are fixed to the both take-up bearings 170, 172 and slidably connected to the slide brackets 174, 175 such that the threaded push arms 176, 177 may slide through the slide brackets 174, 175 within a range of travel defined by the end of the threaded push arms 176, 177 and the take-up bearings 170, 172. Compression springs 178, 179 are coaxially mounted around the threaded push arms 176, 177 between the slide brackets 174, 175 and the take-up bearings, so that the springs 178, 179 are compressed thereby imparting a pre-tensioning effect upon the pulleys, and in turn the belt 145.

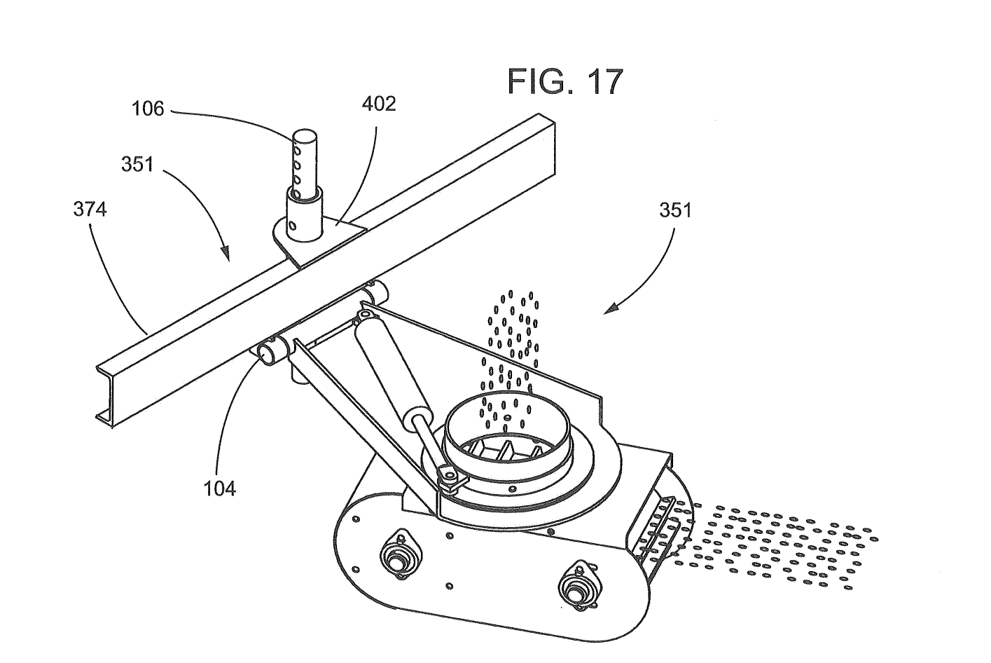

Referring to FIG. 17, another embodiment of a spreader apparatus 351 is shown. In this embodiment the mounting mechanism 402 is disposed intermediate a truck mount 374 such the spreader apparatus is disposed intermediate the sidewalls of the vehicle when mounted thereto. The spreader apparatus 351 is similar in other respects to the spreader apparatus 51 of FIG. 6.

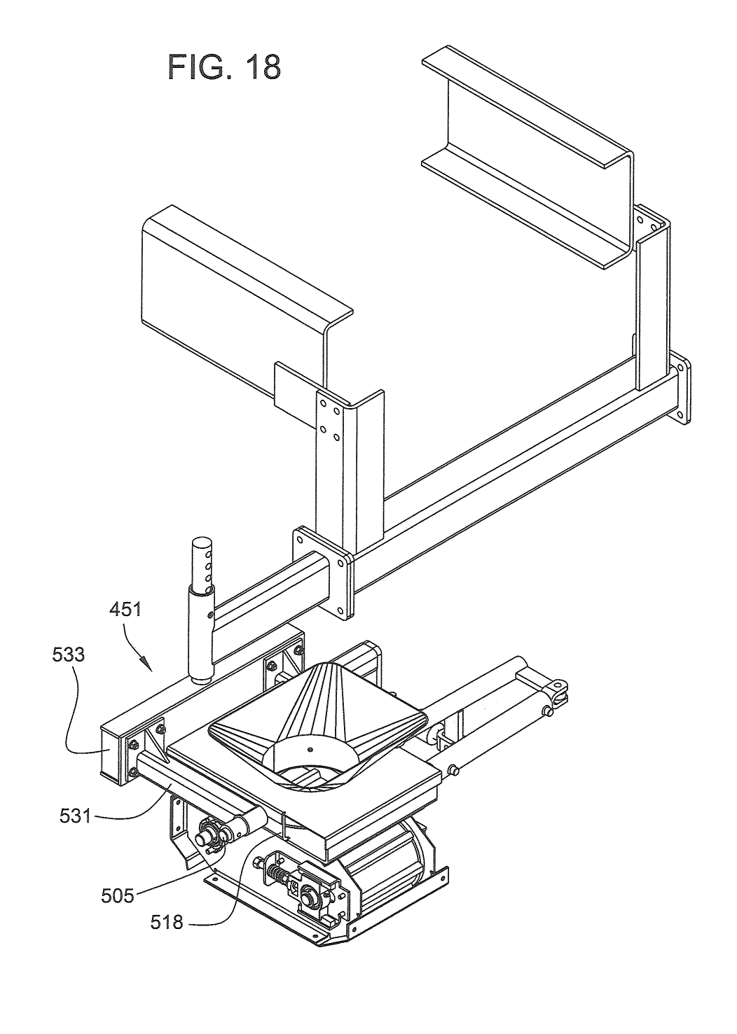

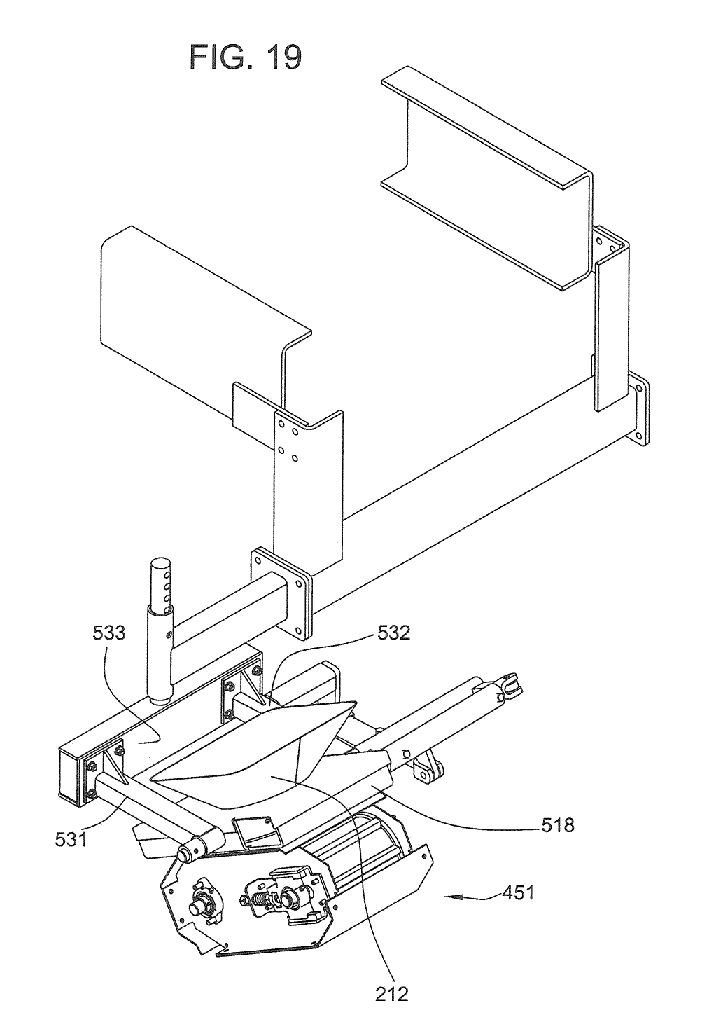

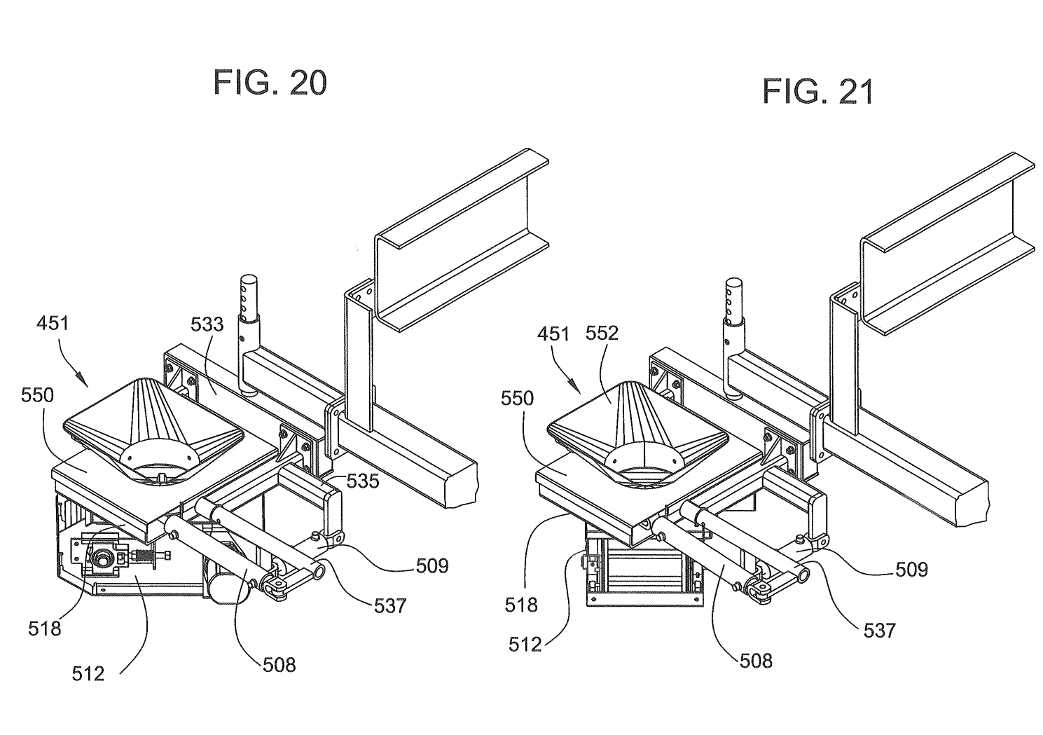

Referring to FIGS. 18-21, another embodiment of a spreader apparatus 451 is shown. The spreader apparatus includes a pair of support arms 531, 532 extend from a mounting beam 533 on either side of the pivot pan 518. The support arms 531, 532 are pivotally attached to the pivot pan at an intermediate position thereof to define a pivot axis 505. Referring to FIG. 20, an L-shaped arm 535 extends from the support arm 532. A pitch control actuator 509 is connected between the L-shaped arm 535 and a connecting bar 537. The pitch control actuator 508 can move the spreader 512 between the transport position when actuated, as shown in FIG. 19, and the operating position when retracted, as shown in FIG. 18.

Referring to FIGS. 20 and 21, a directional control actuator 508 extends between the connecting bar 537 and belt housing 512. The directional control actuator 508 can move the spreader 451 between the full street-side rotation position when actuated, as shown in FIG. 20, and the full curb-side rotation position when retracted, as shown in FIG. 21.

Referring to FIG. 21, the spreader 451 includes a pivot pan cover 550 mounted on top of the pivot pan 518. A feed chute 552 is provided on top of the pivot pan cover 550 in order to facilitate the collection of material dispensed from the body of the vehicle. The spreader 451 is similar in other respects to the spreader 51 of FIG. 6.

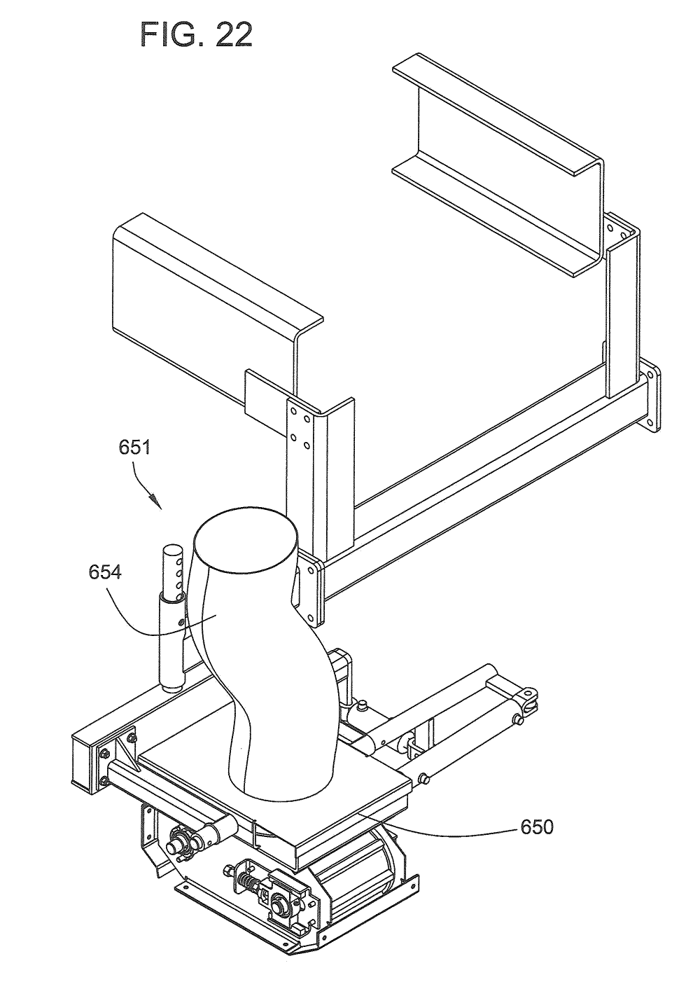

Referring to FIG. 22, in another embodiment of a spreader apparatus 651, a flexible plastic hose 654 is connected between the pivot pan cover 650 and extends a predetermined distance therefrom. The hose 654 can be connected to a discharge end of an auger assembly or other conveyor assembly to facilitate the delivery of material therefrom to the opening spreader. The spreader 651 is similar in other respects to the spreader 451 of FIG. 18.

In other embodiments, the spreader apparatus can include a deflector that is pivotally connected to belt housing. A deflector actuator, connected between the deflector and the belt housing, allows the deflector to be moved between a retracted position wherein the deflector is disposed out of the material discharge path and a raised position wherein the deflector is interposed in the material discharge path, thereby resulting in a dispersed, broadcast material discharge. A broadcasted discharge can be advantageous when a broader material dispersion is desired, such as when crossing an intersection.

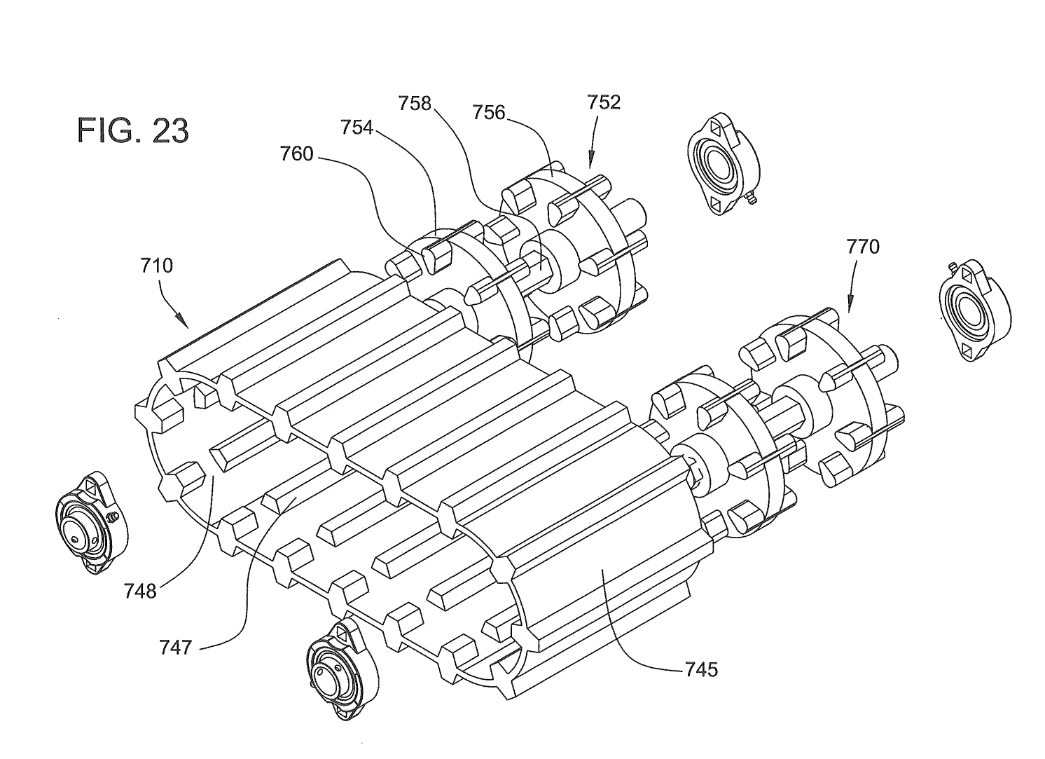

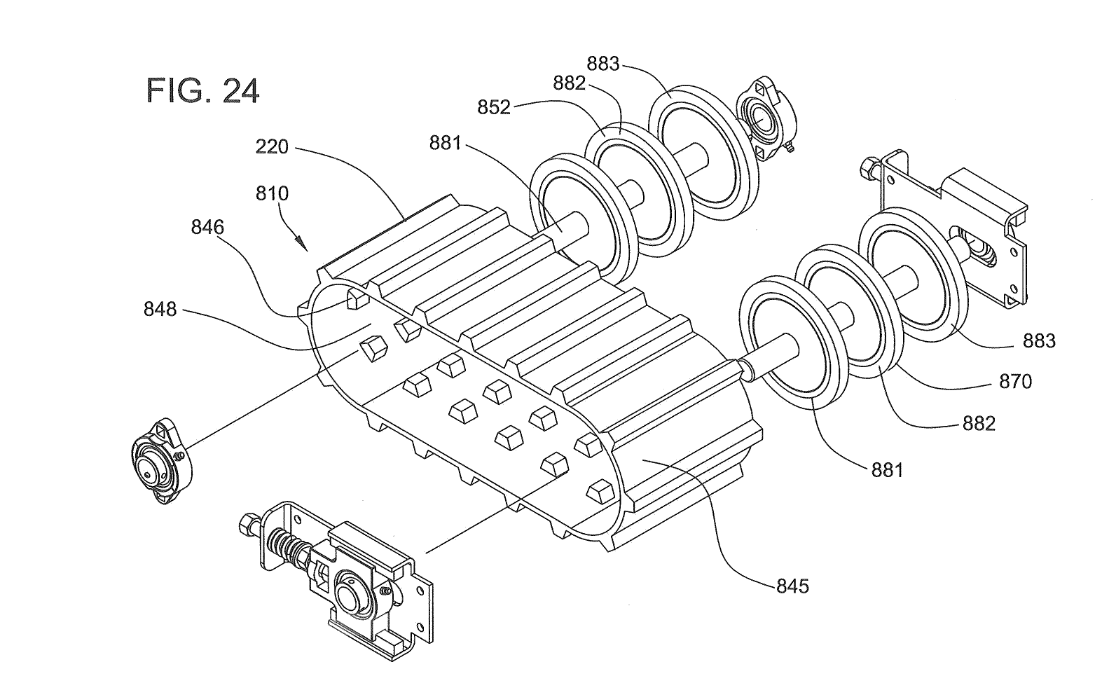

Referring to FIG. 23, another embodiment of a belt mechanism 710 suitable for use in the present invention is shown that includes a belt 745 with a plurality of cogs 747 extending inwardly from the inside surface of the belt 745. Each cog 747 extends transversely across the width of the belt 745 with a pair of gaps 748 adjacent the outer edges. The gaps 748 of the cogs 747 align to accommodate a plurality of pulleys each with its own outwardly extending cogs that can engage the cogs 747 of the belt 745. A drive pulley 752 with a pair of drive pulley plates 754, 756 rigidly connected together by a drive shaft 758. Each of the drive pulley plates 754, 756 has cogs 760 extending outwardly therefrom. The cogs 760 of the drive pulley 752 can positively engage the cogs 747 of the belt 745 to facilitate the driving of the belt 745 by the drive pulley. The belt mechanism 710 also includes an idler pulley 770 constructed in the same manner as the drive pulley 752. The belt mechanism 710 can be similar in other respects to the belt mechanism 110 of FIG. 16.

In yet another embodiment of a belt mechanism 810 suitable for use in the spreader apparatus of the present invention, illustrated in FIG. 24, the belt 845 includes a plurality of columns of guide cogs 846, which form parallel channels 848 on the inside surface of the belt 845. The belt mechanism 810 includes a drive pulley 852 and an idler pulley 870 that are substantially similar to each other. Each pulley 852, 870 includes multiple (three shown) pulley plates 881, 882, 883 which are in spaced relationship with each other such that they are respectively disposed within the channels 848 defined by the guide cogs 846. When the belt mechanism 810 is operating, the guide cogs 846 restrict the lateral movement of the pulley plates to facilitate the alignment of the pulleys 852, 870 with the belt 845. The belt mechanism 810 can be similar in other respects to the belt mechanism 710 of FIG. 23.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-16. (canceled)

17. A method for reducing the post impact dispersion of material dispensed from a moving vehicle by expelling the material from the vehicle at a horizontal velocity that is equal to and opposite of the velocity of the vehicle, characterized by the following method steps:
dispensing material from a dump body into an auger assembly through an opening in a tailgate pivotably attached to the dump body;
transporting all material entering the auger assembly to the left side of the auger assembly through use of an auger situated at the bottom of the assembly such that the material will fall through an opening at the far left side of the auger assembly, wherein the auger speed is set by a controller that monitors vehicle speed and calculates the appropriate auger speed necessary to achieve a material flow rate that will ensure a desired material coverage density of the surface;
collecting the material dispensed from the auger assembly opening in an inlet of a spreader apparatus mounted below the auger assembly opening; and
using a belt mechanism within the spreader apparatus to impart upon the material entering the spreader apparatus a velocity that is equal and opposite to that the vehicle is moving when the material is dispensed out of an outlet in the rear of the spreader, wherein the speed of the belt mechanism, which is driven by a motor, is set by the controller which calculates the motor speed necessary to ensure the material speed will be zero relative to the surface when it leaves the spreader outlet.

18. The method of claim 17, wherein the discharge path of the spreader can be moved from left to right by use of an actuator that can rotate the spreader from left to right around an axis within a predetermined range of travel.

19. The method of claim 18, wherein the material discharge may be manipulated between a narrow discharge and a broadcasting discharge by rotating a deflector shield into and out of the discharge path around a second axis.

20. The method of claim 18, wherein the material leaving the spreader outlet is sprayed with a liquid dispensed from a pre-wet application hose.
